(19) United States
(12) Patent Application Publication
(10) Pub. No.: US 2016/0063318 A1
(43) Pub. Date: Mar. 3, 2016

(54) SYSTEMS, METHODS, AND DEVICES FOR TRACKING ATTENTION OF VIEWERS OF A DISPLAY DEVICE

(71) Applicant: Elwha LLC, Bellevue, WA (US)

(72) Inventors: Jesse R. Cheatham, III, Seattle, WA (US); William David Duncan, Mill Creek, WA (US); Roderick A. Hyde, Redmond, WA (US); Stephen L. Malaska, Redmond, WA (US)

(21) Appl. No.: 14/469,215

(22) Filed: Aug. 26, 2014

(51) Int. Cl. G06K 9/00; H04N 7/18; G06Q 30/02; H04N 5/225

(52) U.S. Cl. CPC G06K 9/00335; H04N 5/225; H04N 7/181; G06K 9/00288; G06K 9/00255; G06Q 30/0273

(57) ABSTRACT

An apparatus or system includes a permission management component, a usage component, an attention component, and a report component. The permission management component is configured to determine a permission level corresponding to a display device. The permission level may indicate an amount of data or type of data that can be gathered. The usage component is configured to receive sensor data from one or more sensors observing a viewing area of a display device. The display device may include the one or more sensors, and the sensor data may be received in accordance with the permission level. The attention component is configured to determine, based on the sensor data, an attention level of one or more individuals to the display device. A report component is configured to report the attention level to a content provider.

If an Application Data Sheet (ADS) has been filed on the filing date of this application, it is incorporated by reference herein. Any applications claimed on the ADS for priority under 35 U.S.C. §§119, 120, 121, or 365(c), and any and all parent, grandparent, great-grandparent, etc. applications of such applications, are also incorporated by reference, including any priority claims made in those applications and any material incorporated by reference, to the extent such subject matter is not inconsistent herewith.

### CROSS-REFERENCE TO RELATED APPLICATIONS

The present application claims the benefit of the earliest available effective filing date(s) from the following listed application(s) (the “Priority Applications”), if any, listed below (e.g., claims earliest available priority dates for other than provisional patent applications or claims benefits under 35 USC §119(e) for provisional patent applications, for any and all parent, grandparent, great-grandparent, etc. applications of the Priority Application(s)).

### PRIORITY APPLICATIONS

None

If the listings of applications provided above are inconsistent with the listings provided via an ADS, it is the intent of the Applicant to claim priority to each application that appears in the Domestic Benefit/National Stage Information section of the ADS and to each application that appears in the Priority Applications section of this application.

All subject matter of the Priority Applications and of any and all applications related to the Priority Applications by priority claims (directly or indirectly), including any priority claims made and subject matter incorporated by reference therein as of the filing date of the instant application, is incorporated herein by reference to the extent such subject matter is not inconsistent herewith.

### BRIEF DESCRIPTION OF THE FIGURES

FIG. 1 is a schematic block diagram of a system for tracking an attention level to a display device.

FIG. 2 is a schematic block diagram of a display device.

FIG. 3 is a schematic diagram illustrating a top view of a physical region near a display device.

FIG. 4 is a schematic block diagram of a usage system.

FIG. 5 is a schematic block diagram of an attention tracking system.

FIG. 6 is a schematic flow-chart diagram illustrating a method for tracking an attention level to content on a display device.

### DETAILED DESCRIPTION

In the following detailed description, reference is made to the accompanying drawings, which form a part hereof. In the drawings, similar symbols typically identify similar components, unless context dictates otherwise. The illustrative embodiments described in the detailed description, drawings, and claims are not meant to be limiting. Other embodiments may be utilized, and other changes may be made, without departing from the spirit or scope of the subject matter presented here.

Display screens are used on a large range of electronic devices and for a wide range of purposes. Display screens, such as televisions, monitors, or the like, are often used to watch video programming, play video games, play music, browse the web, or consume other types of content. Often, when content is provided to a display screen, there is little or no way to track how many individuals are consuming the content, how much attention individuals who are present are paying to the content, or how individuals are reacting to the content.

Applicants have recognized a need for, and the present disclosure presents, systems, methods, and devices for tracking attention of viewers of a display device. The attention tracking can be used to provide feedback on content, prove to advertisers that content was received by an individual or household, or determine targeted content or advertisements for an individual or household.

In one embodiment, an apparatus or system includes a permission management component, a usage component, an attention component, and a report component. The permission management component is configured to determine a permission level corresponding to a display device. The permission level may indicate an amount of data or type of data that can be gathered. The usage component is configured to receive sensor data from one or more sensors observing a viewing area of a display device. The display device may include the one or more sensors, and the sensor data may be received in accordance with the permission level. The attention component is configured to determine, based on the sensor data, an attention level of one or more individuals to the display device. A report component is configured to report the attention level to a content provider.

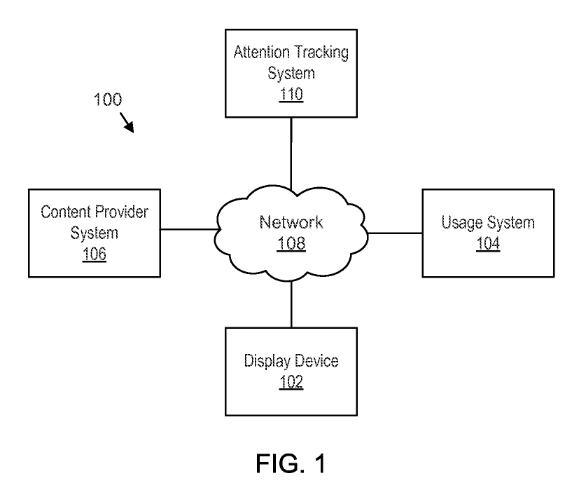

Turning to the figures, FIG. 1 is a schematic block diagram illustrating one embodiment of a system 100 for tracking an attention level of individuals to content displayed on a display device. The system 100 includes a display device 102, a usage system 104, a content provider system 106, and an attention tracking system 110 connected via a network 108. The network 108 may include one or more communication networks such as one or more local area networks (LAN), wide area networks (WAN), cellular networks (e.g., such as a 3GPP network), the Internet, and the like.

The display device 102 may include a system configured to be located with an end viewer. For example, the display device 102 may be a display device or a system located with the display device which can be viewed by one or more viewers. The display device 102 may gather and forward data in accordance with a permission level or account that is associated with the display device 102. In one embodiment, the gathered data may be forwarded to the usage system 104 so that the data can be processed, stored, and/or use to determine likes, dislikes, or other information about the viewers or environment of the display device 102. In one embodiment, the usage system 104 may correspond to a provider of the display device 102. The usage system 104 may reduce a price, increase content access, or provide other benefits or functions to the viewers of the display device 102 based on the gathered data and/or the permission of an account corresponding to the display device 102.

The content provider system 106 may include a system corresponding to an entity or system that provides content to the display device 102. For example, the content provider system 106 may include a server that provides television, radio, web, or other content to the display device 102. The attention tracking system 110 may receive sensor data or other data from the display device 102 or usage system 104 and determine an attention level one or more individuals pay to the display device 102. In one embodiment, one or more of the systems or devices 102, 104, 106, and 110 may be included within a single system or device. For example, the attention tracking system 110 may be part of the display device 102, usage system 104, or content provider system 106 in some embodiments.

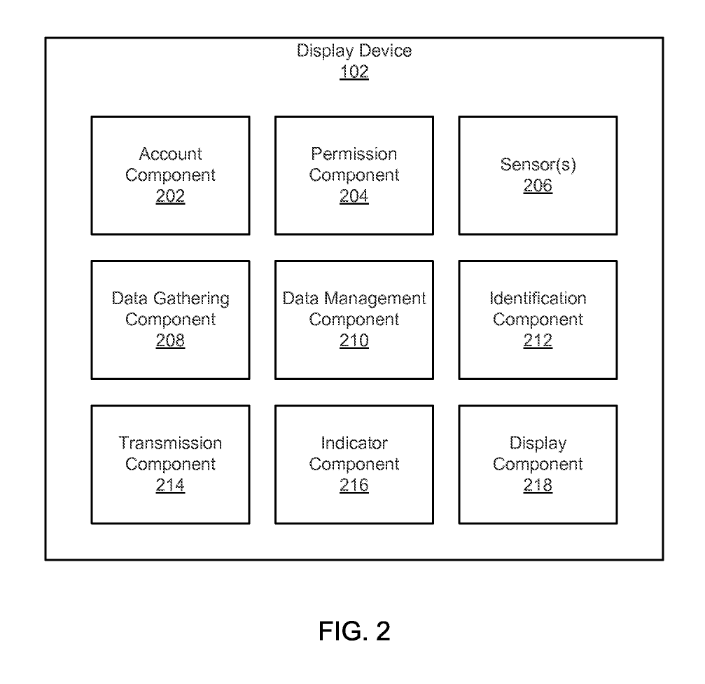

FIG. 2 is a schematic block diagram illustrating components of one embodiment of a display device 102. The display device 102 includes an account component 202, a permission component 204, one or more sensors 206, a data gathering component 208, a data management component 210, an identification component 212, a transmission component 214, an indicator component 216, and a display component 218. The components 202-218 are given by way of example only. All of the components 202-218 may not be included in all embodiments. In fact, some embodiments may include any one or a combination of two or more of the components 202-218. In one embodiment, one or more of the components 202-218 may be located remotely, for example, as a part of the usage system 104 or content provider system 106. In one embodiment, the data management component 210, identification component 212, and/or other components may be included in the usage system 104.

In one embodiment, the account component 202 is configured to determine an account status for an account corresponding to the display device 102. The account component 202 may associate the display device 102 with a specific account, such as an account of an owner, purchaser, or renter of the display device 102. In one embodiment, the account component 202 may determine a status of an associated account. For example, the account component 202 may communicate with the usage system 104 or content provider system 106 to determine a current account status for a corresponding account. As another example, the account component 202 may access local memory of the display device 102 to retrieve an account status.

In one embodiment, the account component 202 determines an account status that includes an amount owed for a display device, such as the display device 102 or a display device to which the display device 102 is connected. For example, a business or entity may provide the display device 102 to an account owner without receiving full monetary payment for the display device 102. In one embodiment, the display device 102 is provided to the account owner without any monetary costs. The account status may track the owed monetary price of the display device 102 even if the amount is not billed. For example, the monetary price may be tracked and reduced due to monetary payments by an account holder and/or gathered data.

Similarly, the account status may include a monetary price for an available replacement display device. In some embodiments, the account status can keep track of multiple potential replacement devices, each with different monetary prices. For example, a 60 inch high definition display device can be available for replacement at a higher price than a 32 inch low definition display device. For example, the replacement display device may include a device that may be obtained by an account owner if the account owner pays the monetary price. In one embodiment, the monetary price indicates a price for exchanging a current display device or display device 102 for the replacement display device. In one embodiment, in the event that the monetary price for an available replacement display device has been reduced to zero or below, the user can be supplied with the available replacement display device for free. In some embodiments, the user may periodically be provided with replacement display devices (e.g., once a year) in exchange for permitting an appropriate amount of data to be gathered and transmitted over the time period between replacements.

In one embodiment, the account status may include an access level for content, features, or services available on the display device. For example, the access level may indicate what programming can be accessed by the display device 102. The programming may include television channels, websites, streaming video services, radio channels, and/or any other type of content that may be displayed by a display or rendered on an audio output device. In one embodiment, the access level may indicate content that is available for free access on the display device 102. In one embodiment, the access level may indicate content that is available for an additional fee or for an increased permission level. In one embodiment, the access level may indicate that content from a provider of the display device 102 is available but that content from other providers is not available. For example, the access level may indicate non-authorized content providers and authorized content providers. The non-authorized content providers may only be accessible for an additional fee or for a specific permission level. In one embodiment, a feature (such as displaying 3D images or movies, video chats, or the like) may be allowed or blocked based on the access level.

In one embodiment, the account status includes information about how much data needs to be collected in order to obtain a specific replacement display device. For example, a plurality of different replacement display devices may be listed with different amounts/types of data that need to be collected. Once a specific amount and/or type of data is collected, the account owner may be able to obtain or exchange for the new device. In one embodiment, the account status indicates a ratio for an amount of content to amount of usage data to be gathered. For example, the ratio may indicate that one unit of time of content can be consumed in exchange for one unit of time of gathered data (e.g., a ratio of 1 to 1). Other ratios are also possible, and the ratio may be addressed to encourage the user to allow the gathering of data and/or allowing the gathering of certain types of data. In one embodiment, the account status indicates that access to content from the other content providers (non-authorized content) is more expensive than content from the provider of the display device (authorized content). In one embodiment, the access level of the account status may indicate content from only providers authorized by a provider of the display device is allowed.

The permission component 204 determines a permission level corresponding to the display device 102. For example, the permission level may correspond to an account associated with the display device 102. In one embodiment, the permission component 204 determines the permission level by retrieving the permission level from storage local to the display device 102 or querying the usage system 104 or content provider system 106. In one embodiment, the permission level is based on a contract signed by an account holder or another indication from the account holder that grants the specific permission of the permission level. In one embodiment, the permission level is based on the account status. For example, a lower amount owed on the display device 102 or a greater access level to content may correspond to a permission level that allows the gathering of more data.

In one embodiment, the permission level indicates permissions for gathering data from the display device 102. For example, the permission level indicates permission to a provider of the display device 102 or an entity owning or operating the usage system 104 or content provider system 106 to gather data from the display system. In one embodiment, the permission level may indicate permissions for gathering data using the one or more sensors 206 of the display device 102. The permissions may indicate an amount of data that can be gathered. For example, the permission for an amount of data may include an amount of data measured in memory size, measured by time, or measured by any other measurement.

In one embodiment, the permissions indicate a number of hours of data to be gathered during a time interval. For example, the permissions may allow for a specific number of hours to be gathered per month. As another embodiment, the permission may indicate a cumulative number of hours that may be gathered, after which no more data may be gathered for a life of the display device 102. The permission level may indicate time periods during which data may or may not be gathered. In one embodiment, the permission level indicates a time of day during which the data may be collected, such as during work-day hours, prime time, or any other time. In one embodiment, the permission level indicates that the data may only be collected during usage of the display device 102 or other display device.

The permissions may indicate a type of data that can be gathered. For example, the type of data may include video, audio, radar, infrared, 3D, wireless signals, or other types of data. In one embodiment, the permission level may indicate that gathering a specific type of data is authorized while gathering another type of data is not authorized. For example, the permission level may indicate that radar data may be gathered but video data gathering is blocked.

In one embodiment, the permission level may correspond to a specific permission tier. For example, a number of permission tiers may be available and the permission level may correspond to one of the permission tiers to allow. Each permission tier may have corresponding permissions for data gathering. In one embodiment, a higher-level tier (i.e., higher or greater permission level) may correspond to greater permissions for data gathering while a lower tier (i.e., lower permission level) may have reduced or no permissions for data gathering.

In one embodiment, the permission component 204 may receive or obtain a change to the permission level. In one embodiment, the change to the permission level may be based on one or more of a change to an account status or input from an account owner or other user. For example, the permission component 204 may obtain an indication that the permission level has been reduced based on receipt of a payment decreasing the monetary amount for the amount owed for the display device 102. As another example, the permission component may receive input from a user changing the permission level to increase or decrease the amount of data or type of data that can be gathered.

In one embodiment, the account status may be based on the permission level for the account. For example, the permission level may, at least in part, determine the account status. In one embodiment, increases to the permissions granted by an owner for gathering data may result in a reduced monetary amount owed on the display device, reduce a cost for a replacement display device, and/or increase access levels to content. In one embodiment, a specific permission level may correspond to one or more specific account statuses. In one embodiment, a user, such as an account owner, may be able to increase the permission level to save money and/or increase content and feature access. For example, the permission level may determine which channels, shows, features, etc. are accessible or functional on display device 102.

In one embodiment, the account status may indicate a monetary amount corresponding to one or more of the amount owed for the display device 102 and the monetary price for the available replacement display device. In one embodiment, when the permission level is increased, the account component 202 receives an indication that the monetary price has been reduced based on the permission level. This change may be indicated to the user through an on-screen message, a message in an account, or any other messaging system to convey changes to the account to an account owner.

In one embodiment, the account status indicates a monetary amount corresponding to the amount owed for the display device 102, such as the display device 102 or a display device connected to the display device 102. In one embodiment, account component 202 determines that the access level for content or services available on the display device 102 is reduced or increased in response to the permission level change. In one embodiment, the account component 202 determines that the amount owed for the display device 102 is reduced or increased in response to the permission level change. In one embodiment, the account component 202 determines that the monetary price for the available replacement display device is reduced or increased in response to the permission level change. In one embodiment, the account component 202 provides an indication on the display device 102 of the updated account status. For example, the display device 102 may provide a menu or account interface where information is displayed about the current account status and/or any changes to the account status.

In one embodiment, the display device 102 may include one or more sensors 206 for sensing activity in a physical region near the display device 102. The sensors 206 may include any type of visual, audio, range finding, or other sensors. For example, the display device 102 may include a camera such as a still image camera, a video camera, an infrared camera, or other camera for capturing visual and/or infrared images of a physical region near the display device 102. In one embodiment, the sensors 206 are positioned or oriented to sense activity or gather data in a region where individuals can view a display screen of the display device 102 or a display screen connected to the display device 102. In one embodiment, the sensors 206 include a 3D camera or other 3D sensor for capturing 3D images. For example, the 3D camera may include two or more camera lenses having offset positions in relation to each other. The cameras may then be used to get a 3D image or view of a region near the display device 102.

In one embodiment, the sensors 206 include an audio sensor, such as a microphone, to capture audio data near the display device 102. The microphone may capture audio from a display device and/or from viewers of the display device. For example, audible reactions or comments of one or more viewers may be captured by the microphone. In one embodiment, the sensors 206 include a range finding sensor or other sensor to determine distances or 3D spacing or locations of objects. In one embodiment, the sensors 206 include a radar unit or light detection and ranging (LIDAR) unit for determining a 3D shape of a viewing area and/or individuals within the viewing area.

In one embodiment, the sensors 206 may include an antenna to detect wireless signals in the region near the display device 102. For example, the antenna may be used to determine a radio environment near the display system and/or identify types of devices or protocols that are being used to communicate by devices or systems near the display device 102. In one embodiment, the sensors 206 may include a global positioning system (GPS) module that detects a location of the display device 102.

The data gathering component 208 gathers data in accordance with a permission level for the display device 102. For example, the data gathering component 208 may gather data based on the permission level determined by the permission component 204. The data gathering component 208 may activate and gather data from the one or more sensors 206 regarding activity in the physical region near the display device 102. For example, the data gathering component 208 may gather one or more of images, video, infrared images, 3D images, radar data, LIDAR data, audio data, location data, or any other data about a region near the display device 102. Similarly, the data gathering component 208 may detect wireless signals present at the display device 102. For example, the data gathering component 208 may detect wireless signals including signals corresponding to one or more of a wireless router, a wireless phone, a cellular phone, a computing device, a broadcast signal, and the like.

In one embodiment, the data gathering component 208 gathers usage data regarding how the display device 102 is used. For example, the data gathering component 208 may gather data about content or programming displayed on the display device 102. Data about the content or programming may include information about a title, rating, genre, actor, or other information. Additionally, data about advertisements or other related content may also be gathered. In one embodiment, the data gathering component 208 gathers data about devices connected, via a cable or wireless port, to the display device 102 (e.g., digital video disc (DVD) players, gaming consoles, computing devices, or any other connected device). The data about connected devices may include information about a manufacturer, user, device type, software programs or versions loaded onto or running on the devices, or other information about the connected device. The data gathering component 208 may store the gathered data in memory for later access, processing, or transmission.

The data gathering component 208 gathers data based on the permission level for the account corresponding to the display device 102. For example, the data gathering component 208 may gather types of data at times or in amounts indicated by the permission level. The data gathering component 208 may activate or deactivate the sensors 206 as required by the permission level to ensure that data is only gathered as approved by the permissions of the account. The data gathering component 208 may also determine whether a sensor 206 is blocked or not functioning. For example, if the data gathering component 208 is not able to gather data in accordance with a permission level, the data gathering component 208 may block usage of the display device 102 to consume content. In one embodiment, the display device 102 is rendered inoperable to display or render content if the sensors are blocked, disabled, incorrectly positioned, or the like. In one embodiment, the display device 102 may disable certain features of the display device 102 if sensor data cannot be collected. For example, features to disable include a display screen, a speaker, 3D rendering, video/audio output ports, or the like. In one embodiment, the account component 202 may modify an account status (e.g., increase an amount owed for display device 102, increase the monetary price for an available replacement device, etc.) if sensor data cannot be collected.

In one embodiment, the data gathering component 208 may also gather data about input provided by a viewer to the display device 102. For example, the data gathering component 208 may gather data about a change of input or content, such as changing the channel or changing an input source. In one embodiment, the data gathering component 208 may gather data about settings of the display device, such as a speaker loudness setting, the brightness of a display screen, or the like.

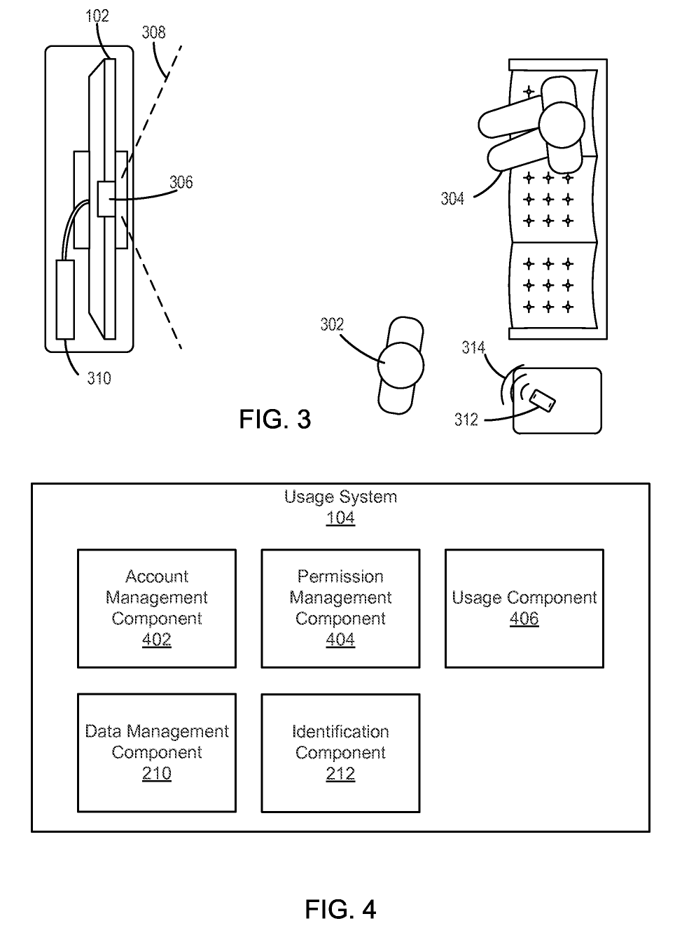

FIG. 3 is a schematic diagram illustrating a top view of a physical region near a display device 102. In the depicted embodiment, the display device 102 includes a television. The television is situated for viewing by viewers 302 and 304. The display device 102 includes a sensor unit 306 for observing a physical region (such as the viewing area 308 indicated by dotted lines) near the display device 102. The display device 102 is connected to an input source 310. A wireless device 312 is located nearby emitting wireless signals 314.

In one embodiment, sensor unit 306 houses one or more sensors 206 to observe viewing area 308. The data gathering component 208 may gather data about individuals and objects in the viewing area 308 by activating and receiving data from one or more sensors of the sensor unit 306. As discussed above, the data gathering component 208 may also gather data about the connected input source 310. Additionally, the data gathering component 208 may detect the wireless signals 314 or other radio signals in the radio environment of the display device 102.

Returning to FIG. 2, the data management component 210 conditions gathered data for storage, transmission, or reporting of the data. In one embodiment, the data management component 210 conditions the data by removing potentially identifying information. For example, in one embodiment, the data management component 210 anonymizes the gathered data by removing identifying information gathered by the sensors. The identifying information removed may include metadata, faces within image data, images of nearby documents, or other information that might link the gathered data to the account owner, viewers, or the like, for privacy reasons. In some embodiments, the data management component 210 removes data in accordance with a current permission level for the display device 102. For example, some permission levels may require the removal of identifying information while other permission levels may allow the identifying information to remain in the gathered data.

The identification component 212 is configured to detect one or more human users viewing a display of the display device 102. The identification component 212 may receive sensor data gathered by the one or more sensors 206 and detect the presence of humans in a viewing area based on the sensor data. In one embodiment, the identification component 212 may detect a human using visual images, using techniques such as image recognition, object recognition, face detection, or the like. In one embodiment, the identification component 212 may detect a human using audio data such as microphone data to detect a human voice, breathing, or the like. In one embodiment, the identification component 212 may detect a human using infrared images to identify a heat signature of a person.

In one embodiment, the identification component 212 may detect a human based on the detection or recognition of a 3D object. For example, a 3D camera, LIDAR unit, radar unit, or the like may be able to detect a 3D shape or signature of a human to detect that a human is present. In another embodiment, the identification component 212 may detect a human based on a detected motion using a motion sensor, a radar unit, 3D camera, LIDAR unit, camera, or the like. In yet another embodiment, the identification component 212 may detect a human based on a heat signature, such as a heat signature detected by an infrared camera. The identification component 212 may also detect the presence of objects or animals within view/range of the sensors 206. For example, the identification component 212 may identify specific types of objects or animals which may be used for advertising purposes for the viewing location. In one embodiment, the identification component 212 determines how many people are currently watching a display, or at least are detectable or viewable by the sensors 206.

The identification component 212 may also be configured to identify specific humans. For example, the identification component 212 may determine a unique identity for a specific individual. In one embodiment, the identification component 212 stores or retrieves one or more identities with identifying features that may be used to identify human viewers. For example, the identifying features may include any physical aspect of the users such as facial features or dimensions for face recognition or other dimensions or physical aspects of a body of a viewer. In one embodiment, voice recognition or other audio information regarding a human can be used to identify the human. In yet another embodiment, wireless signals may be associated with a specific individual. For example, a signal from a cell phone or other wireless communication device may be detected and used to determine that a specific individual is present.

In one embodiment, the identification component 212 associates information with an identity. For example, the identification component 212 may associate an account with the identity of a user or may associate a permission level with the identity. For example, the account may be associated with a specific identity as an account owner for the account. Similarly, the identification component 212 may associate an identity with content viewed by the corresponding individual. For example, the identification component 212 may associate the identity with content displayed by the display device 102 while the individual is present. In one embodiment, a portion of sensor data and/or usage data for the display device 102 may be associated with each specific identity of viewers present for the gathered sensor and usage data. In one embodiment, the term usage data is given to mean data about how a display device 102 (or corresponding display) is used, including sensor data. For example, usage data may include what content is displayed, what connected devices are used, what features of the display are used, how many viewers are present, or the like. In one embodiment, the identification component 212 stores identities and associated data locally with the display device 102 or at another location, such as at the usage system 104.

In one embodiment, the identification component 212 determines whether a specific identity corresponds to a restricted identity. For example, the restricted identity may correspond to a specific identity selected by an account holder. In one embodiment, the identification component 212 limits an amount or type of data associated with the restricted identity. For example, no data may be associated with the restricted identity to maintain privacy for the corresponding individual. In one embodiment, the identification component 212 permits storage or transmission of associated with restricted identities only if this data is aggregated with data from multiple identities.

Returning to FIG. 3, the identification component 212 may detect the presence of the viewers 302 and 304 because they are within the viewing area 308. In one embodiment, the identification component 212 may identify the viewers 302, 304 based on face recognition or any other recognition technique, such as those discussed above. Content displayed on the display device 102 is also associated with the identities and stored for analysis or later targeted content or advertising. In one embodiment, the identification component 212 may also detect other objects near the display device 102, such as furniture, pets, decorations, or other objects.

Returning to FIG. 2, the transmission component 214 transmits data gathered by the display device 102 to a remote location, such as the usage system 104, content provider system 106, or attention tracking system 110. The transmission component 214 may include a wired or wireless network interface card (NIC) for transmitting and receiving information using an electronic communication standard. In one embodiment, the transmission component 214 transmits data gathered by the data gathering component 208. The data transmitted to remote systems may be in accordance with a permission level determined by the permission component 204. In one embodiment, the transmission component 214 transmits the data after it has been modified or redacted by the data management component 210. Furthermore, the transmission component 214 may transmit data regarding detected or identified individuals or objects, as determined by the identification component 212. In one embodiment, the transmission component 214 may transmit data associated with an identity so that ongoing usage and/or content viewed by a specific individual can be tracked. The transmission component 214 may transmit the data on a periodic basis, such as monthly, weekly, daily, hourly, or the like. In one embodiment, the transmission component 214 transmits the data as it is received from other components of the display device 102, as appropriate.

In one embodiment, the transmission component 214 securely transmits data to only trusted entities. For example, the transmission component 214 may store an identifier or uniform resource locater (URL) corresponding to a specific entity to which information should be transmitted. Passwords, encryption, or other features may be used to determine that the receiving entity is the correct entity or that transmitted data cannot be read by unauthorized parties.

The transmission component 214 may also determine whether the data can be transmitted to a trusted entity. For example, the transmission component 214 may determine whether an Internet connection is available or if a remote server is available. In one embodiment, if the transmission component 214 is not able to transmit data in accordance with a permission level, the transmission component 214 may block usage of the display device 102 to consume content. In one embodiment, the display device 102 is rendered inoperable to display or render content if there is no Internet connection or the trusted server or entity is not available. In one embodiment, the display device 102 may disable certain features of the display device 102 if the data cannot be transmitted. For example, features to disable include a display screen, a speaker, 3D rendering, video/audio output ports, or the like.

The indicator component 216 is configured to indicate that data is currently being gathered. In one embodiment, the indicator component 216 determines whether data is being gathered and provides an indication that data is currently being gathered by the data gathering component 208. For example, the indicator component 216 may provide an on-screen indication on a display screen that sensor data or other usage data is currently being gathered by the data gathering component 208. As another example, the indicator component 216 may include a separate indicator light, such as a light-emitting diode (LED), which the indicator turns on when the data is being gathered. Thus, the indicator component 216 may indicate to one or more individuals in a viewing area of the display device that the data gathering component 208 is currently gathering data about activity in the physical region near the display device 102.

In one embodiment, the indicator component 216 also indicates that changes to an account or permission level have occurred. For example, a message may be displayed on a display indicating that a permission level has been changed, or that an account status has changed. A viewer or account owner may thereby know that some changes have been made. For example, an account owner may determine that requested changes have taken place or that unrequested changes have occurred. If the owner did not request the changes, the owner may follow up to determine why they have changed and/or correct the account status or permission level.

The display component 218 is configured to display content on a display screen. The display component 218 may include a video card, a display (such as a display screen or projector), and/or a video port for attaching to a separate display screen. In one embodiment, the display component 218 receives input from a user to select content for display by the display device 102. In one embodiment, the display component 218 displays content in accordance with an account status as determined by the account component 202. For example, the display component 218 may block display of unauthorized content or features while allowing access to content or features authorized by the account status.

The display device 102 may be implemented in a variety of physical formats, depending on a variety of embodiments. In one embodiment, the display device 102 may include a housing that houses one or more, or all, of the components 202-218 in a single device. For example, the display device 102 may include a “smart television” with built in-display, ports, and components 202-218. In one embodiment, one or more of the components 202-218 may be housed in separate housings or physical devices. For example, the display device 102 may include a port for connecting to a separate display screen or projection element. The display device 102 may be embodied as one or more of a television, a computer monitor, a video projection system, a phone, a tablet computer, a laptop, a desktop computer, and a portable digital assistant (PDA).

FIG. 4 is a schematic block diagram illustrating components of one embodiment of a usage system 104. The usage system 104 includes an account management component 402, a permission management component 404, a usage component 406, a data management component 210 and an identification component 212. The components 402-406 and 210-212 are given by way of example only. All of the components 402-406 and 210-212 may not be included in all embodiments. In fact, some embodiments may include any one or a combination of two or more of the components 402-406 and 210-212.

The account management component 402 manages one or more accounts for one or more display devices 102. In one embodiment, the account management component 402 maintains an account status for each account. For example, the account management component 402 may maintain a database with entries for account statuses for each of a plurality of accounts. As discussed above, an account status may include one or more of an amount owed for a display device (such as display device 102 of FIG. 2), a monetary price for an available replacement display device, and an access level for content or services available on the display device. In one embodiment, the account management component 402 determines what an account status for a specific account should be and stores the account status for later usage or for access by a corresponding display device 102. For example, an account component 202 may access the usage system 104 to determine a current account status.

In one embodiment, the account management component 402 determines the account status based on a permission level to gather data for the corresponding account. For example, higher permission levels may correspond to an account status that is more favorable (e.g., more access, more features, and/or less cost) to an account owner while lower permission levels correspond to an account status that is less favorable. In one embodiment, the account management component 402 detects a change to a permission level and changes the account status based on a change to the permission level. For example, an access level for content or services available on the display device 102 may be reduced or increased when the permission level is changed. Similarly, the cost for a replacement device or an amount owed on the display device 102 may be reduced or increased when the permission level is changed and/or if the permission level has been at least at a specific permission level for a required length of time.

In one embodiment, the account management component 402 determines the account status based an amount of data gathered from a display device 102. For example, as more data is gathered, the account status may be adjusted to reward an account owner or viewer. In one embodiment, the account management component 402 determines the account status based on input, payment, or other action by a user. For example, an account owner may be able to select a modification to the account status by selecting an option to have access to a specific type of content or obtain a new display device 102. In one embodiment, the user can select the option to gain access to content and corresponding changes may be made to the permission level for the account to compensate for the change. In one embodiment, the change to the account status by the user may include permission to modify the permission, modify the payment, and/or bill the account.

In one embodiment, the account management component 402 changes the account status by reducing a price for a replacement device or system and/or reducing an amount owed on a display device 102. For example, the account management component 402 reduces the price for a replacement or amount owed to zero when a high enough permission level is set, when a specific amount of data has been gathered, and/or if a full price has been paid. In one embodiment, the account management component 402 changes the account status by modifying a ratio of an amount of time available to access content or services to an amount of usage data that needs to be gathered. For example, the ratio may be increased or decreased to require more or less data per unit time of content displayed on the display device 102. In one embodiment, the account management component 402 may modify a cost to access content. In one embodiment, the account management component 402 changes the account status by modifying a content access level to allow access to content providers not associated with a provider of the display device 102.

The permission management component 404 maintains a permission level for one or more accounts for one or more display devices 102. For example, the permission management component 404 may manage a permission level for each of the accounts managed by the account management component 402. As discussed above, the permission level may indicate permissions for gathering one or more of an amount of data and a type of data with respect to a display device 102 linked with the account.

In one embodiment, the permission management component 404 determines or updates the permission level for the account. In one embodiment, the permission management component 404 determines the permission level based on an amount paid by a user. In one embodiment, the amount owed on a display device discussed above may, at least initially, correspond to a cost of the display device minus the amount paid by the user. For example, the amount paid may correspond to a price paid for a display device (such as the display device 102), content access, or the like. In one embodiment, the amount paid may indicate that no fee was paid. For example, the permission management component 404 may determine that an account has a higher permission level (i.e., greater permission to gather data) if a lower amount was paid for the display device or system. Similarly, the permission management component 404 may determine a permission level based on an amount paid for access to content.

In one embodiment, the permission management component 404 determines the permission level based on an agreement accepted by an account owner or viewer of a display device 102. For example, an owner may receive a display device 102 for a reduced price (or for free) in return for agreeing to allow data to be gathered using the display device 102. Similarly, a viewer or owner may select an option when using the display device 102 to allow gathering of data based on a permission level. In one embodiment, the account owner or a viewer may select an option to obtain access to content in return for an increase in the permission level.

In one embodiment, the permission management component 404 determines the permission level based on an amount of data gathered by a display device 102. For example, after a specified amount of data has been gathered the permission management component 404 may reduce the permission level to reduce or stop the gathering of data.

The usage component 406 is configured to obtain usage data and/or sensor data from one or more display devices 102. For example, the usage component 406 may receive data gathered, generated, and/or transmitted by the display device 102. The received data may include data about activity in a region near the display device 102. The received data may include any of the data discussed above in relation to the display device 102 such as camera images, video, 3D images, infrared data, audio data, radar data, LIDAR data, location data, or the like. Similarly, the received data may include data about content displayed on the display device 102, input sources connected to the display device 102 (e.g., via a wired or wireless connection), software used on connected devices, or other information about input sources or displayed content. In one embodiment, the received data includes data about a radio environment of the display device 102, such as information about wireless signals corresponding to one or more of a wireless router, a wireless phone, a cellular phone, a computing device, broadcast signals, and/or the like. In one embodiment, the usage component 406 may receive information about a number of viewers, viewer identities, or any other information determined by the identification component 212 or other components of the display device 102. In one embodiment, the data may include data that has been modified to remove identifying information or other privacy sensitive information from the data gathered by the data management component 210. The usage component 406 may receive and store the data from the display device 102 for processing.

In one embodiment, the usage system 104 may include a data management component 210 and an identification component 212. For example, the functionality of the data management component 210 and/or the identification component 212 may be located with the usage system 104 as well as or instead of at the display device 102. For example, the data management component 210 may modify data received from the display device 102 to remove identifying information or increase privacy of those located near the display device 102. In one embodiment, a data management component 210 located on the usage system 104 may also aggregate data from multiple display devices 102 with data from one or more other accounts to reduce the likelihood that the information can be tracked back to a specific display device 102 or account.

In one embodiment, the data obtained or generated by the usage system 104 may be stored for usage by a corresponding entity or content providers. For example, the data may be used to study how people consume content and/or determine more accurate numbers regarding how many people watch specific programming. Viewing environments, watching habits, and the like may be determined from the data. Similarly, other data about locations, such as radio environments, locations of display devices 102, or the like, may be obtained. In one embodiment, the information received by the usage component 406 may allow for entities to determine target content or advertisements for a specific household or determine how much to charge for an advertisement based on how many people are present. In one embodiment, the usage system 104 may provide data received from the display device or generated by the usage system 104 to the content provider system 106 and/or attention tracking system 110.

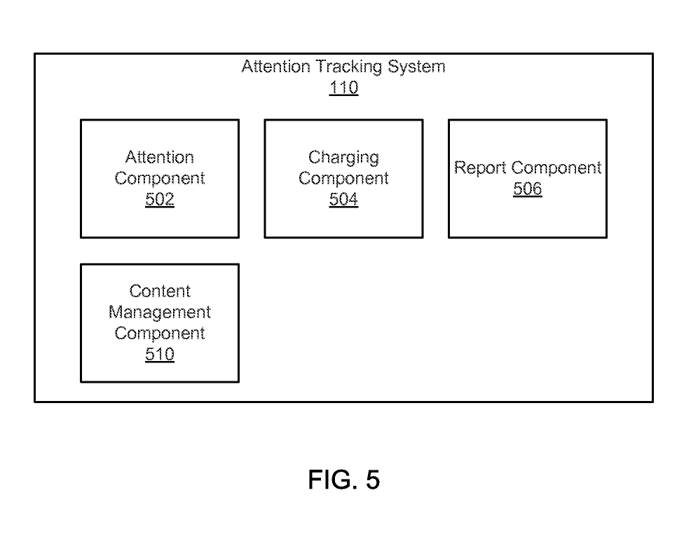

FIG. 5 is a schematic block diagram illustrating components of an attention tracking system 110. The attention tracking system 110 includes an attention component 502, a charging component 504, a report component 506, and a content selection component 510. The components 502-510 are given by way of example only and may not all be included in all embodiments. In some embodiments, one or more of the components 502-510 may be located within one or more of a display device 102, usage system 104, or content provider system 106, or as part of another device or system.

The attention component 502 is configured to determine an attention level of one or more individuals to a display device. In one embodiment, the attention component 502 determines the attention level based on data provided by the display device, such as the display device 102 of FIG. 2. For example, the attention level may be determined or derived based on sensor data, identity information, input received from the user by the display device, or the like. In one embodiment a setting, such as speaker loudness, screen brightness, or other information about settings of the display device may be used to determine how much attention an individual is paying to the display device.

In one embodiment, the attention component 502 may determine an attention level based on a presence of an individual. For example, a lowest attention level may correspond to an individual at least being present within a range of one or more sensors or a viewing area of the corresponding display device. For example, the attention component 502 may determine that there is at least a minimal level of attention. In one embodiment, the attention component 502 may determine, based on the sensor data, whether an individual is looking at a display screen of the display device. For example, the attention component 502 may determine a direction of a gaze of an individual and determine whether the individual is looking at the screen. Any type of gaze tracking, eye tracking, or head position tracking based on images, 3D information, or the like, may be used to determine whether the individual is looking at the display.

In one embodiment, the attention component 502 may determine an attention level based on an emotion detected in the individual. For example, the attention component 502 may predict an emotional state of the individual based on movement, body language, facial expressions, verbal sounds, or the like. For example, if a viewer opens their mouth, gasps, makes a statement about what is displayed on the display, or has any other response to content on the display, the attention component 502 may determine that the individual has a high level of attention to the display. In one embodiment, the attention component 502 may predict the emotion as frightened, interested, annoyed, angry, happy, smiling, laughing, or the like based on the sensor data. In one embodiment, the attention component 502 may determine the attention level as one of a plurality of attention levels ranging from lower attention levels to higher attention levels. In one embodiment, the more an individual stares at a display screen, reacts, or shows evidence of emotion, the higher the attention level detected by the attention component 502 will be. Similarly, input provided by the user may indicate an attention level or other reaction to the content on the display. For example, if a user changes the channel the attention component 502 may determine that the individual was bored, offended, or had some other reaction to the content.

In one embodiment, the attention component 502 associates the attention level or emotion with content displayed or rendered on a display. For example, if the attention component 502 determines that an individual has a specific attention level during display of specific content, the attention component 502 may create a record of the attention level that indicates the specific content and/or timing within the specific content. In one embodiment, this information may be associated with a specific individual or may be anonymized to show aggregate reactions of individuals to content. In one embodiment, the attention component 502 associates the attention level with a specific timing of the content.

In one embodiment, the attention component 502 determines a timing of a specific attention level with content on the display. In one embodiment, the attention component 502 determines a timing of the attention level in relation to content on the display device. In one embodiment, the attention component 502 determines a timing, in relation to content on the display device, that an individual of the one or more individuals leaves the viewing area. In one embodiment, the attention component 502 determines a timing, in relation to content on the display device, that an individual of the one or more individuals returns to the viewing area. In one embodiment, the attention component 502 determines a timing, in relation to content on the display device, that an individual of the one or more individuals begins looking at the display device. In one embodiment, the attention component 502 determines a timing, in relation to content on the display device, that an individual of the one or more individuals looks away from the display device. In one embodiment, the attention component 502 determines a timing, in relation to content on the display device, that the display device is powered off. In one embodiment, the attention component 502 determines a timing, in relation to content on the display device, that a user changes content displayed on the display device.

In one embodiment, the attention component 502 associates any of the timings of attention level, viewer input to a display device (such as powering off or changing a channel), or an individual leaving or coming within range of a sensor with the content and/or an identity of the user. In one embodiment, the timing of the content may be used by content providers to identify problem areas in the content and/or develop targeted content for a specific household, individual, or similar households or individuals. In one embodiment, the timing information may be used, in the aggregate, to determine when people are getting bored, angry, or otherwise tuning out of a show. Future programming may then be developed, if desired, to avoid types or periods in content where attention levels generally drop or increase, or when content input is changed.

The charging component 504 is configured to determine a cost to charge an advertiser or content provider based on the attention level determined by the attention component 502. For example, the charging component 504 may determine the cost based on the attention level to the specific content. The cost may be a per individual cost, per display device cost, or a cost in the aggregate based on an overall average attention level and the number of viewers of the content. In one embodiment, the higher the attention level, the higher the determined cost. In one embodiment, the charging component 504 determines a higher or lower cost based on an identity of an individual present in the viewing area. For example, if the individual corresponds to a demographic at which an advertisement is targeted, the charging component 504 may determine a higher cost than if the individual does not fall within the target demographic. Similarly, the charging component 504 may determine the cost based on attention levels at the display device to one or more past advertisements. For example, if an advertisement is similar to other advertisements that got high attention levels from the individual, the charging component 504 may determine a higher cost to charge. In one embodiment, the charging component 504 determines the cost based on a number of individuals present in the viewing area. In one embodiment, the cost determined by the charging component 504 may be based on whether input was received to change the input (e.g., change an input source or a channel) while the specific content was being presented. For example, a higher cost may be determined if the full content is rendered by the display device, rather than just a portion of it.

The report component 506 is configured to provide a report to a content provider. For example, the report may be provided to an advertiser, copyright owner, or other party that provided the content. The report may indicate an attention level, cost, number of viewers, or other information for the content. In one embodiment, the report component 506 may generate the report based on information received from the attention component 502 and the charging component 504. The report may be used as proof as to how well the content was received and may be used as justification for a bill or cost for providing the content to the display device. In one embodiment, the report component 506 may include enough sensor data (e.g., with identifying information removed) or information derived from sensor data to provide proof that the cost or bill is justified.

The content selection component 510 is configured to select content for display on a display device. In one embodiment, the content selection component 510 selects advertising or other content for display on a display device based on previous attention levels, emotions, or the like received at the display device. For example, the facial expression, emotions, attention levels, or the like for previous content or advertisements may be recalled to select content to be displayed. In one embodiment, the content selection component 510 selects the content based on an identity of an individual currently present at the display device. In one embodiment, the content selection component 510 selects the content based on other data gathered by the display device, such as other objects detected by sensors. For example, if the display device detects a specific pet currently or previously at the display device, the content selection component 510 may select advertising or other content related to the type of pet or that may be interesting to an owner of the pet. In one embodiment, the content selection component 510 may send an indication of the selection to a content provider or request content based on the selection so that the selected content can be provided to the display device. In one embodiment, the content selection component 510 provides an indication to the content provider system 106 or usage system 104 to provide the content to the display device 102.

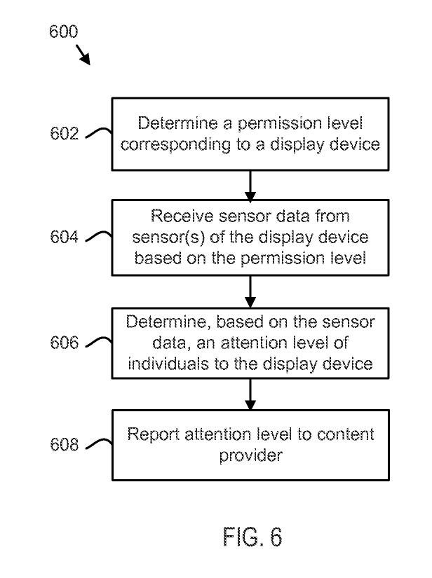

FIG. 6 is a schematic flow-chart diagram illustrating a method 600 for determining an attention level to content on a display device. In one embodiment, the method 600 may be performed by an attention tracking system 110 and/or a usage system 104, such as the attention tracking system 110 of FIG. 5 and/or the usage system 104 of FIG. 4. In one embodiment, the method 600 may be performed by a usage system 104 or display device 102 that has a built in attention tracking system 110.

The method 600 begins and a permission management component 404 determines 602 a permission level corresponding to a display device. For example, the permission management component 404 may determine 602 the permission level based on an account linked with the display device. In one embodiment, the permission level indicates an amount of data or type of data that can be gathered. In one embodiment, the permission level may be determined 602 by a permission component 204.

A usage component 406 receives 604 sensor data from one or more sensors observing a viewing area of a display device. For example, the viewing area may include a physical region near the viewing device where one or more individuals may view a display screen of the display device, hear a speaker of the display device, and/or otherwise consume content provided by the display device. In one embodiment, the sensor data may include image data, heat data, location data, 3D data, or the like. In one embodiment, the usage component 406 receives 604 the sensor data from a display device in accordance with the permission level. In one embodiment, the sensor data may be received 604 or otherwise obtained by a data gathering component 208.

An attention component 502 determines 606, based on the sensor data, an attention level of one or more individuals to the display device. In one embodiment, the attention component 502 determines 606 an attention level based on whether an individual is present within an audible or visible range of the display device. In one embodiment, the attention component 502 determines 606 the attention level based on an expression or body language of the individual. For example, the attention component 502 may detect or predict an emotion of the individual to determine 606 the attention level. In one embodiment, the attention component 502 may determine the attention level based on input provided by a viewer to the display device or input source.

A report component 506 reports 608 the attention level to a content provider. For example, the report component 506 may report 608 the attention level to the content provider system 106 as a bill providing the content (such as an advertisement) to one or more display devices or as proof that the content was delivered and received by one or more individuals at the display device. In one embodiment, the report component 506 reports 608 the attention level by providing a report to the content provider that includes the attention level and/or a cost or amount charged for providing the content to the user. In one embodiment, the report component 506 reports 608 the attention level to provide feedback on how the content was received. For example, information about the attention level may allow a content provider to target a household, individual, or demographic or may allow the content provider to develop content in the future to be better received (e.g., to have a higher attention level).

This disclosure has been made with reference to various example embodiments. However, those skilled in the art will recognize that changes and modifications may be made to the embodiments without departing from the scope of the present disclosure. For example, various operational steps, as well as components for carrying out operational steps, may be implemented in alternate ways depending upon the particular application or in consideration of any number of cost functions associated with the operation of the system; e.g., one or more of the steps may be deleted, modified, or combined with other steps.

Additionally, as will be appreciated by one of ordinary skill in the art, principles or components of the present disclosure may be reflected in a computer program product on a computer-readable storage medium having computer-readable program code means embodied in the storage medium. Any tangible, non-transitory computer-readable storage medium may be utilized, including magnetic storage devices (hard disks, floppy disks, and the like), optical storage devices (CD-ROMs, DVDs, Blu-ray Discs, and the like), flash memory, and/or the like. These computer program instructions may be loaded onto a general purpose computer, special purpose computer, or other programmable data processing apparatus to produce a machine, such that the instructions that execute on the computer or other programmable data processing apparatus create a means for implementing the functions specified. These computer program instructions may also be stored in a computer-readable memory that can direct a computer or other programmable data processing apparatus to function in a particular manner, such that the instructions stored in the computer-readable memory produce an article of manufacture, including implementing means that implement the function specified. The computer program instructions may also be loaded onto a computer or other programmable data processing apparatus to cause a series of operational steps to be performed on the computer or other programmable apparatus to produce a computer-implemented process, such that the instructions that execute on the computer or other programmable apparatus provide steps for implementing the functions specified.

While the principles of this disclosure have been shown in various embodiments, many modifications of structure, arrangements, proportions, elements, materials, and components, which are particularly adapted for a specific environment and operating requirements, may be used without departing from the principles and scope of this disclosure. These and other changes or modifications are intended to be included within the scope of the present disclosure.

The foregoing specification has been described with reference to various embodiments. However, one of ordinary skill in the art will appreciate that various modifications and changes can be made without departing from the scope of the present disclosure. Accordingly, this disclosure is to be regarded in an illustrative rather than a restrictive sense, and all such modifications are intended to be included within the scope thereof. Likewise, benefits, other advantages, and solutions to problems have been described above with regard to various embodiments. However, benefits, advantages, solutions to problems, and any element(s) that may cause any benefit, advantage, or solution to occur or become more pronounced are not to be construed as a critical, a required, or an essential feature or element. As used herein, the terms “comprises,” “comprising,” and any other variation thereof are intended to cover a non-exclusive inclusion, such that a process, a method, an article, or an apparatus that comprises a list of elements does not include only those elements but may include other elements not expressly listed or inherent to such process, method, system, article, or apparatus.

While various aspects and embodiments have been disclosed herein, other aspects and embodiments will be apparent to those skilled in the art. The various aspects and embodiments disclosed herein are for purposes of illustration and are not intended to be limiting, with the true scope and spirit being indicated by the following claims.

What is claimed is:

1. An apparatus comprising:
a permission management component configured to determine a permission level corresponding to a display device, wherein the permission level indicates an amount of data or type of data that can be gathered;
a usage component configured to receive sensor data from one or more sensors observing a viewing area of a display device, the display device comprising the one or more sensors, and the sensor data received in accordance with the permission level;
an attention component configured to determine, based on the sensor data, an attention level of one or more individuals to the display device; and
a report component configured to report the attention level to a content provider.

2. The apparatus of claim 1, wherein the sensor data comprises camera images of the viewing area.

3. The apparatus of claim 2, wherein the camera images comprise video frames.

4. The apparatus of claim 2, wherein the camera images comprise three-dimensional images.

5. The apparatus of claim 2, wherein the camera images comprise infrared images.

6. The apparatus of claim 1, wherein the sensor data comprises audio data from the viewing area.

7. The apparatus of claim 1, wherein the sensor data comprises radar data of the viewing area.

8. The apparatus of claim 1, wherein the usage component is further configured to receive data indicating content displayed on the display device.

9. The apparatus of claim 8, wherein the attention component associates the attention level with current content on the display device.

10. The apparatus of claim 8, wherein the attention component determines a timing of the attention level in relation to content on the display device.

11. The apparatus of claim 8, wherein the attention component determines a timing, in relation to content on the display device, that an individual of the one or more individuals leaves the viewing area.

12. The apparatus of claim 8, wherein the attention component determines a timing, in relation to content on the display device, that an individual of the one or more individuals returns to the viewing area.

13. The apparatus of claim 8, wherein the attention component determines a timing, in relation to content on the display device, that an individual of the one or more individuals begins looking at the display device.

14. The apparatus of claim 8, wherein the attention component determines a timing, in relation to content on the display device, that an individual of the one or more individuals looks away from the display device.

15. The apparatus of claim 8, wherein the attention component determines a timing, in relation to content on the display device, that the display device is powered off.

16. The apparatus of claim 8, wherein the attention component determines a timing, in relation to content on the display device, that a user changes content displayed on the display device.

17. The apparatus of claim 1, wherein the usage component is further configured to receive data about what devices are connected to the display device via a physical or wireless connection.

18. The apparatus of claim 1, further comprising an identification component configured to determine an identity of at least one of the one or more viewers.

19. The apparatus of claim 18, wherein the attention component is further configured to associate at least a portion of the sensor data and display device usage with the identity.

20-39. (canceled)

40. A method comprising:
determining a permission level corresponding to a display device, wherein the permission level indicates an amount of data or type of data that can be gathered;
receiving sensor data from one or more sensors observing a viewing area of a display device, wherein the display device comprises the one or more sensors and the sensor data is received in accordance with the permission level;
an attention component configured to determine, based on the sensor data, an attention level of one or more individuals to the display device; and
a report component configured to report the attention level to a content provider.

41-58. (canceled)

59. The method of claim 40, further comprising predicting an emotion of the one or more individuals based on the sensor data.

60. The method of claim 59, further comprising selecting content to display on the display device based on the predicted emotion.

61. The method of claim 59, wherein predicting the emotion comprises predicting based on detection of a facial expression of the one or more individuals.

62. The method of claim 40, further comprising determining a cost to charge to an advertiser.

63. The method of claim 62, wherein determining the cost comprises determining based on the attention level to current content.

64. The method of claim 62, wherein determining the cost comprises determining based on an identity of an individual present in the viewing area.

65. The method of claim 62, wherein determining the cost comprises determining based on a number of individuals present in the viewing area.

66. The method of claim 62, wherein determining the cost comprises determining based on attention levels at the display device to one or more past advertisements.

67. The method of claim 40, further comprising selecting an advertisement to provide to the display device.

68. The method of claim 67, wherein selecting the advertisement comprises selecting based on detection of a facial expression of the one or more individuals.

69. The method of claim 67, wherein selecting the advertisement comprises selecting based on an identity of an individual present in the viewing area.

70. The method of claim 67, wherein selecting the advertisement comprises selecting based on attention levels at the display device to one or more past advertisements.

71. The method of claim 40, further comprising one or more of:
anonymizing the sensor data to remove personally identifying information; and
aggregating the sensor data with sensor data from one or more other accounts.

72. The method of claim 40, wherein determining the permission level comprises determining based on an amount paid for the display device.

73. The method of claim 40, wherein determining the permission level comprises determining based on an agreement accepted in relation to the account.

74. The method of claim 40, wherein determining the permission level comprises determining a permission level that indicates a number of time units of sensor data that can be collected during a time interval.

75. The method of claim 40, wherein determining the permission level comprises determining a permission level that indicates a time of day during which the sensor data may be collected.

76. The method of claim 40, wherein determining the permission level comprises determining a permission level that indicates that the sensor data is only collected during usage of the display device.

77. The method of claim 40, further comprising maintaining an account status for the account based on the permission level, the account status comprising one or more of an amount owed for the display device, a monetary price for an available replacement display device, and an access level for content or services available on the display device.

78. The method of claim 77, further comprising modifying the account status based on the attention level.
